(19) United States
(12) Patent Application Publication
(10) Pub. No.: US 2009/0233251 A1
(43) Pub. Date: Sep. 17, 2009

(54) CANDLE, A CANDLE HOLDER, A CANDLE HOLDING SOCKET, A CANDELABRUM AND A METHOD OF MAKING A CANDLE

(75) Inventors: Giuseppe AMBROGGIO, Rivoli (IT); Piergiorgio AMBROGGIO, Torino (IT)

Correspondence Address: HARNESS, DICKEY & PIERCE, P.L.C., P.O. BOX 828, BLOOMFIELD HILLS, MI, 48303, US

(73) Assignee: PRICE'S PATENT CANDLES LIMITED, Bedford (GB)

(21) Appl. No.: 12/398,444

(22) Filed: Mar. 5, 2009

(30) Foreign Application Priority Data
Mar. 6, 2008 (EP) 08004154.4

(51) Int. Cl. F23D 3/16; C11C 5/00

(52) U.S. Cl. 431/292; 431/295; 431/289; 264/241

(57) ABSTRACT

A candle socket is disclosed that has passage through the candle socket. A candle is supported on the candle socket. The candle comprises a body of candle fuel with a wick extending longitudinally through the body. The candle comprises a root extending longitudinally away from the body and forming a butt end of the candle. The root is sized to pass through the passage through the socket. The root extends longitudinally in the passage through the candle socket. The root comprises candle fuel supporting a bottom portion of the wick in the root. A candle holder is also disclosed that comprises such a candle socket and also includes a collection receptacle associated with it and arranged to receive candle residue dropping from the candle socket. A filter that allows molten candle fuel through and catches wick residue falling from the candle socket is arranged between the hole in the base and the collection receptacle.

### FIELD

The present invention is concerned with a candle and a method of making one. The invention is also concerned with a candle holding socket, a candle holder for holding a candle and a candelabrum for holding a number of candles.

### BACKGROUND

Candles generally comprise a column of solid fuel with an internal wick rising longitudinally through it. The solid fuel is nearly always some form of wax, with paraffin wax being the most common. Candles made from gel, soy, beeswax, and vegetable products are also available.

To ignite a candle, a lit match or other flame being used to light the candle is brought into proximity with a top surface of the candle and the wick protruding from it. The heat from the flame first melts the solid fuel and the liquid fuel moves upward through the wick via capillary action. The liquid fuel is vaporised and burns to form the candle flame. The heat from the candle flame is sufficient to maintain this chain of events and is thus self-sustaining.

Candles both for private and public use are often supported in candelabra. These candelabra have found extensive use in Churches. The candelabra generally have a frame with a number of candle holding sockets mounted to it.

In a simple design of candelabra, removing the residual wax and wick after each candle has burned out has been performed by scraping and digging the residual wax out of each socket. This is a difficult and tedious chore. It can be imagined just how difficult and tedious this task would be in the case of a very large candelabrum with hundreds of candle holding sockets. The job of doing this in a church having a number of candelabra, each having candles being frequently changed is considerable and time consuming.

An advancement in the art for dealing with this problem of cleaning out each socket by hand has been proposed. Summarised, the advancement involves providing a hole in the base of each of the candle holding sockets and disposing a receptacle beneath the sockets. When the candle has burned down into the socket the wick and wax residue is allowed to drop through the hole and into the receptacle for collecting the waste. This known improvement will be described with reference to FIGS. 1 to 3. U.S. Pat. Nos. 2,530,288 and 679, 984 show examples of known prior art candelabrum with a hole in its candle holding sockets for allowing wax and wick candle residue to fall through.

FIGS. 1 to 3 show an example prior art candelabrum 2. The candelabrum 2 provides a frame 4 supporting eight candle holding sockets 6. FIG. 2 gives a cross section along the dashed line 2-2 of FIG. 1. A candle 8 is shown consisting of a column of solid fuel 14, almost exclusively some type of wax, and a wick 12 extending through its longitudinal axis. The candle sockets 6 can be seen to have a central hole in their base.

FIG. 2 shows candles 8 before the first time they have been lit and FIG. 3 shows just one candle holding socket 6 and the state of the candle after it has been lit and where the burning of the candle 8 has progressed into the candle holding socket 6. The idea behind the improved candle socket 6 is that as the candle burns down to its last dregs of wax and wick, the candle 8 above the hole 16 will be sufficiently molten to pass through the hole 16 in the base of the candle holding socket 6, thereby leaving a clean socket 6 that is ready for receipt of a new candle.

The pan 10 is disposed beneath the sockets 6 so that after the wax and wick residue passes through the hole 16 it is collected in the pan 10. Many candles 8 can burn and pass through the hole before the pan 10 itself needs to be cleaned. In the shown embodiment, the pan is partly filled with water to present the wax and wick residue with a cooling means so that it has solidified before it reaches the base of the pan 10. This makes cleaning of the pan 10 easier as the wax and wick residue has not adhered to the base of the pan 10.

The provision of candle holding sockets with holes has not entirely done away with the need for wax and wick residue to be cleaned from candle holding sockets. In a significant number of instances, the candle extinguishes itself before it is sufficiently molten to pass through the hole in the socket. One mechanism by which this is believed to occur is that as the candle burns down to its butt end, the wax about the wick is soft enough along the length of the wick that the wick wilts or bends. This wilting or bending of the wick causes the flame to extinguish. With reference to FIG. 3, the very end of the wick can be seen to have wilted, but this does not usually cause the flame to extinguish because the rest of the wick is still supported by the solid wax part of the candle. As the candle burns down to its dregs of wax and wick, this supporting effect is relinquished and the candle can be caused to extinguish itself as a result. If this occurs then the wax and wick residue does not become molten enough about the hole to pass through. Wax and wick residue are left in the bottom of the candle holding socket and must be cleaned out manually.

It can also happen that the candle becomes displaced from being disposed with its wick axis aligned with the hole in the base of the socket. In such an instance, the candle can burn down until its very bottom is molten without it being able to pass through the hole. Again the wick will topple over and wax and wick residue will be left in the bottom of the candle.

A further problem with prior art candelabra is that when the residue of wax and wick does successfully pass through the hole, they are mixed together in the collection receptacle making it difficult to re-use the wax.

### SUMMARY

It is a first object of the present invention to provide a candle with improved resistance to self-extinguishing as described above.

To this end, the present invention provides a candle comprising a body of candle fuel with a wick extending longitudinally through the body, the candle is to be supported on a candle holding socket with a passage through the candle holding socket, the candle is characterised in that the candle comprises a root forming a butt end of the candle that is sized to pass through the passage, the root extending longitudinally in the passage away from the body, wherein a bottom portion of the wick is supported in the root.

Preferably, the passage through the candle holding socket includes a hole in a bottom of the candle holding socket and the root is to extend into the hole in the bottom of the candle holding socket.

The candle is to be supported on a candle holding socket, which may be a base of a candle holding socket, while the root extends into the hole. This means that the candle is such that it will interface with the socket at some point to allow it to be seated on the socket. The interface point is a position where as the candle burns to its bottom, a bottom layer will form there that is not yet sufficiently molten to pass through the hole, but is so molten that it does not provide sufficient support to, by itself, prevent the wick from falling over and self-extinguishing. The candle of the present invention, however, offers a root that supports a bottom portion of the wick in the root so as to prevent the wick from falling over when the candle is in this final stage condition. The root is sized to pass through the hole while the candle is supported on the base. Eventually, as the candle continues to burn, the bottom layer will become sufficiently molten to pass through the hole. The weight of the root will pull the molten bottom layer through the hole under gravity. As well as this pulling effect, the root also ensures that the candle is appropriately aligned with the passage.

The root is preferably made of candle fuel supporting the wick in the candle fuel of the root. This configuration can be advantageous for ease of manufacturing. It is also envisaged, however, that some other support structure could be provided about the bottom portion of the wick supported in the root, such as a metal casing for the bottom portion of the wick.

The root may be cylindrical in shape or it may define a frustum of a cone narrowing towards a bottom of the root. The root may even be in the shape of a cone with the point of the cone providing a bottom most point of the candle.

In one preferred embodiment, a bottom of the body of the candle is a base surface for being seated on a base of a candle holding socket. The base surface of the candle defines a surface that is to interface with a base surface of the candle socket. The base surface defines a border around the root and the root extends from the base surface. The base surface may be planar extending in a plane perpendicular to the longitudinal direction of the candle. This preferred configuration allows the candle to be seated by its base surface on the base of a candle holding socket.

The candle is to be supported on the candle holding socket, thereby defining a point at which the candle interfaces with the candle holding socket. The root is a portion of the candle that is sized to pass through the passage through the candle holding socket. Preferably, the root extends into a hole in the candle holding socket and is thus sized to pass through the hole. It has been found that a root having a longitudinal extent of 2 mm or greater can be effective to sufficiently support the wick of the candle. It has also been found that in the case of the root being made of candle fuel that a suitable greatest cross-sectional dimension (e.g. a diameter in the case of a cylindrical or cone shaped root) of the root is 2 mm or greater for providing sufficient support and weight.

It is a second object of the invention to provide a candle socket with a passage through the socket where a candle supported on the base is able to consistently burn to a residual layer and pass through the passage.

Thus, a candle socket with the above described candle held in it is provided, the candle is as above and the candle socket has a passage through the candle socket, the candle is supported on the candle socket and the root extends longitudinally in the passage. Preferably, the passage includes a hole in a bottom of the candle holding socket and the root extends into the hole in the bottom of the candle holding socket.

Preferably, the candle socket comprises a base and the passage includes a hole through the base. The candle is supported on the base and the root extends into the hole. In another form, the candle socket could define the frustum of a cone with opposite ends of the cone being open to provide holes, with a bottom end of the socket being narrower than a top end. The candle is supported on a sidewall of such a candle holding socket. The narrow bottom defines a passage extending through the candle holding socket and the root is sized to pass through the passage. Preferably, the root extends longitudinally in and through the bottom hole.

The candle socket is preferably of a kind that has a sidewall extending along a sidewall of the body of the candle, where the sidewall extends from a base of the candle holding socket.

As the body of the candle burns down to its bottom, the wick remains upright and supported by the root as described above. In order for the candle to be supported on the candle holding socket, it must engage the base at some point along its longitudinal extent. The root extends in the passage through the socket. As the candle burns down, a bottom layer of candle fuel will form that is supported and seated on an interface between the candle holding socket and the candle. The root extends from the bottom layer. The root is able to pass through the passage through the candle holding socket. Thus, the bottom layer will fall through the socket under the weight of the root once it is sufficiently molten that it can no longer resist the pulling force. Accordingly, the root and residue consistently fall through the socket. The root has the effect of aligning the wick of the candle and the wax about the wick of the candle with the passage through the socket. It also has the effect of providing a weight derived pulling force to ensure that when the candle is burned down to a molten bottom layer of the candle, the bottom layer is pulled through the hole. Thus, there is further force pulling the candle remnants though the hole than if the root were not provided.

Preferably, a candle holder is provided that comprises the candle socket described above or a candelabrum comprising a plurality of the sockets, wherein the or each socket is associated with a collection receptacle arranged to receive candle residue falling from the hole.

The collection receptacle allows candle residue from a number of candles to be collected. The receptacle may be removed from association with the candle socket so that the receptacle can be occasionally cleaned.

It is a third object of the present invention to provide a candle holder having means for allowing residual candle fuel passing through a passage through a candle holding socket to be separated so that the candle fuel can be re-used.

Accordingly, a candle holder comprising a candle socket for holding a candle is provided or a candelabrum comprising a plurality of the sockets is provided, the or each socket having a passage through it for allowing residual wick and fuel of the candle to pass through the passage, wherein the or each candle socket is associated with a collection receptacle arranged to receive candle residue passing through the passage, the candle holder is characterised in that a filter is provided between the or each socket and the collection receptacle is for retaining wick material from the candle and allowing molten candle fuel from the candle to pass through the filter.

Preferably, the filter is in thermal contact with the candle socket. In an alternative embodiment, the candle holder comprises a heat source separate from the candle holder, for example a battery powered heat source, that is to heat the filter.

This structure is most preferred to be used with a socket and candle as discussed above where the root of the candle extends in the passage through the socket. In this arrangement, the root dropping from the socket can be caught by the filter. Thermal contact with the socket will mean that the filter can heat up and melt the solid fuel of the root from about the wick. Since the wick remnant will be relatively large, the filter will be able to more cleanly separate the candle fuel from the wick.

A candle held in the socket and supported on the socket will burn down to a bottom layer that is supported and seated on the socket with the root extending in the passage. Once the bottom layer is sufficiently molten that it can no longer hold itself on the base against the weight of the root, the residual candle and root passes through the socket only to be caught by the filter. Molten candle fuel will pass through the filter while any solid wick remnants are caught. The collection receptacle will receive candle fuel in a state separated from any wick remnants, thereby allowing a more straight-forward re-use of the candle fuel. In the preferred form, the filter is thermally connected to the base socket and will heat up so that wax held on its surface will melt and pass through or molten wax hitting its surface will remain molten and pass through. The filter has openings that are sufficiently small to catch the wick remnants. The candle fuel is collected in the receptacle for re-use.

It is a fourth object of the invention to provide a method of making a candle, where a wick of the candle remains sufficiently upstanding to resist self extinguishing as the candle burns down to a bottom layer supported on a candle holding socket.

A method of making a candle comprising a body of candle fuel and a wick extending longitudinally through the body, comprising making the body of candle fuel, providing the body with a root extending away from the body, wherein the candle so made is to be supported on a candle holding socket and the root is sized to pass through a passage through the candle holding socket and is to extend longitudinally in the passage away from the body, and providing the wick extending longitudinally through the body of the candle and into the root such that the wick is supported in the root.

The method can include pouring molten candle fuel into a mould that provides the candle body with the root. Another method would be to make the body of the candle and make the root of the candle and press the root onto a bottom of the body of the candle. Yet another method would be to make a column of candle fuel defining the candle and tool a bottom portion to define the root and the body of the candle. This could be done as the column is spinning about a central longitudinal axis of the column.

There is also disclosed a candle mould for moulding candle fuel of a candle, the candle mould is such that it forms candle fuel into a longitudinal column in the general shape of a candle to provide a candle body and characterised by the mould being such that it forms the column of candle fuel with a root extending longitudinally away from the candle body, wherein the candle so moulded is to be supported on a candle holding socket and the root is to extend into through a passage through the candle holding socket.

Preferred embodiments of the invention will be discussed in the following with reference to the figures. These embodiments serve to give example implementations of the core aspects of the invention discussed above.

### DRAWINGS

FIG. 1 shows the prior art candelabrum discussed above. It is a view from above.

FIG. 2 shows a cross-section along the line 2-2 of FIG. 1.

FIG. 3 shows a side cross section of a prior art candle holding socket.

FIG. 4 shows a side cross-section of a candle according to the present disclosure.

FIG. 5 shows a side cross-section of the candle mounted in a candle holding socket of a candle holder.

FIG. 6 shows a side cross-section of two candles mounted in respective candle holding sockets that are supported on a frame of a very simple candelabrum.

FIGS. 7A, 7B, 7C and 7D show side cross sectional views of candles mounted in candle holding sockets, each in alternative forms.

### DETAILED DESCRIPTION

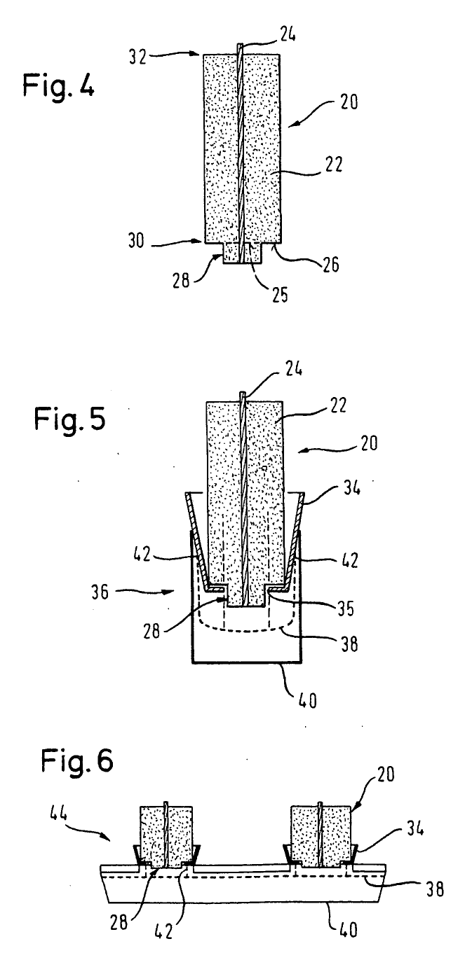

FIG. 4 shows a candle 20 of the present disclosure. The candle 20 comprises a column of solid candle fuel providing a candle body 22 with a wick 24 extending longitudinally through the body 22. The solid fuel is solidified wax that will burn when the wick 24 is lit. The candle 20 has a butt portion and an opposing top end 32. A root 28 forms the butt end of the candle 20. The root extends away from a bottom surface 26 of the body 22 of the candle 20. The wick 24 extends with the root 28 beyond the bottom surface 26 of the candle 20. The wick 24 protrudes from a top surface of the top end 32 of the candle 32. The bottom surface 26 defines an annulus about the central root 28. The bottom surface 26 and a bottom surface of the root 28 may be planar surfaces. It is envisaged that slightly curved bottom surfaces could also be provided. Thus, the body 22 has a part that can support the candle 20 and is of greater cross-sectional dimension than the root 28 of the body 22 of the candle 20 defines a base surface 26 that is to be supported on the base of a candle holding socket.

The root 28 is a cylindrical protrusion from the bottom surface that is made of solid fuel and part of the wick 24. An interface between a bottom 25 of the body 22 of the candle and the root 28 can be imagined. This interface defines a boundary between the body of the candle 22 and a butt end of the candle 20 that is sized to be able to pass through a passage through a candle holding socket to form the root 28. In the present embodiment, the root 28 is sized to pass into a hole formed in the base of a candle holding socket. The candle is sized not to pass through this hole, but instead be supported on the base of the candle holding socket.

A side view of a candle holder 36 is shown in FIG. 5. The candle holder 36 includes a single candle holding socket 34 having a hole 35 in a centre of its base. The root 28 is sized to pass into the hole 35. A passage through the candle holding socket 34 includes the hole 35 and is shown by the dashed lines extending vertically from the hole 35. In the shown embodiment, the root 28 extends longitudinally in the hole 35 and through to the other side. The base surface 26 of the body 22 of the candle 20 is seated on a base of the candle holding socket 34 to support the candle 20 thereon. The candle holding socket 34 includes a side wall upstanding from the base to define a cup shape for the receipt of a butt of the candle.

Attached to the socket 34 and disposed beneath it, with an upwards direction being defined along the line of the wick 24 to the top portion 32 of the candle 20, is a filter 38 that is provided in the form of a metal wire mesh. The filter 38 has openings or pores that allow molten wax to pass through it, but which are small enough to catch a significant, at the least, amount of wick fibres. The filter 38 is arranged so that it catches candle residue passing through the hole 35 in the socket 34. Direct connection between the filter 38 and the socket 34 provides thermal contact between them. Disposed beneath the wire mesh is a collection receptacle 40 arranged to receive molten wax passing through the hole 35 in a base of the candle holding socket 34 and subsequently through the filter 38. The socket 34 is removably mounted on the collection receptacle 40. The collection receptacle 40 may be partly filled with water to act as a cooling means.

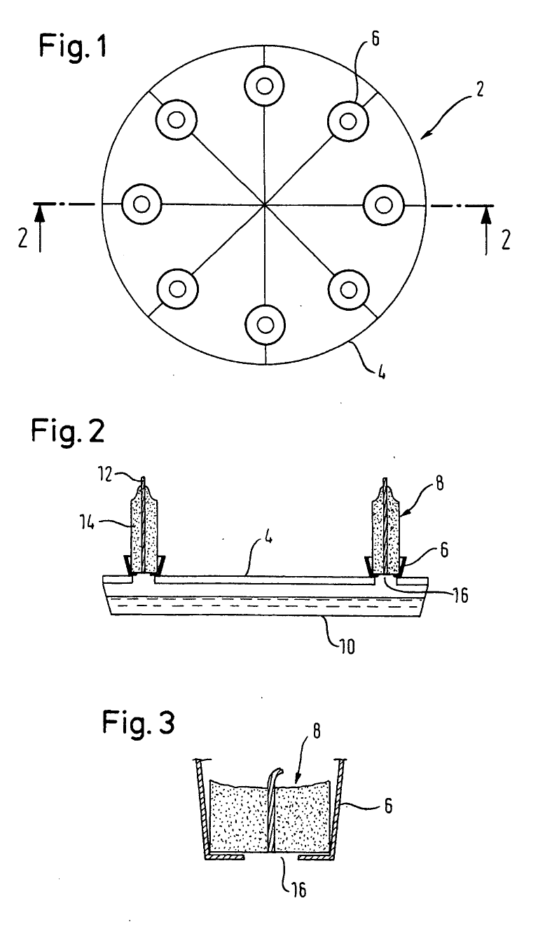

FIG. 6 shows a side view of a candelabrum 44 of the type shown in FIGS. 1 and 2. The candelabrum 44 has a number of candle holding sockets 34 mounted to its frame. Similar to the candle holder of FIG. 5, a filter layer 38 extends beneath the sockets so as to overlap the holes 35 in the sockets 34. The filter layer 38 is attached to the sockets 34 to provide thermal contact points between them. Instead of a filter layer providing a filter for all of the sockets 34, a thermally separate filter 38 can be associated with each socket 34. The collection receptacle 40 is provided in the form of a collection pan upon which a frame supporting the sockets 34 is removably mounted. The receptacle 40 may be partly filled with a cooling means such as water.

The skilled reader will appreciate that the structure of the candle of the present disclosure can be moulded with a suitable mould form. Moulding candles is well known in the candle making art and it would not be burdensome for the skilled person to construct an appropriate mould to form the candle of the present disclosure. Another method would be to extrude a column of candle fuel and tool a portion of it to provide a candle body and a root. Alternatively, a candle body can be formed in ways known in the art and the candle root pressed onto it about a protruding wick.

The use and effects of the candle 20 of the present disclosure will now be described. The candle 20 is inserted with the butt portion 30 leading into a candle holding socket 34. The root 28 is sized to pass through the hole 35 in a base of the socket 34 and extends longitudinally in the hole 35. The root 28 and the hole 35 may loosely or firmly fit one another. The bottom surface 26 of the candle engages the base of the socket 34 and a sidewall of the socket engages a sidewall of the candle 20 to provide further structural support for the candle. The socket 34 may be one of a stand alone candle holder 36 as shown in FIG. 5 or one of the plurality of sockets of a candelabrum 44 as shown in FIG. 6.

The portion of the wick 24 protruding from a top surface of the top end 32 of the candle 20 is lit with a match for example. The candle 20 burns using the solid fuel of the candle body 22. As the candle burns down to the bottom of the candle, a bottom layer of the candle body 22 will form. This bottom layer 22 is pulled by the weight of the root to pass through the hole 35. The bottom layer will resist passing through the hole until the very end of use of the candle body 22 when it will be so molten that the weight of the root 28 overcomes any remaining support between the bottom layer of the body 22 and the base of the socket 34. The candle 20 of the present disclosure allows the wick 24 to remain supported even as the bottom layer of the candle body 22 softens and melts because the depending root provides an annulus of solid fuel around it that structurally supports the root. The solid fuel of the root 28 supports the wick 24 as the candle 20 burns to the bottom surface 26, thereby maintaining an upright configuration for enough of the wick 24 to prevent it falling over and extinguishing itself. As the candle 20 level reaches the bottom surface 26, the bottom layer of the candle body will sufficiently melt at its interface with the base of the socket 34 that it will fall through the hole and the root 28 will fall from the hole 35 in the socket 34. The weight of the root 28 provides a pulling force meaning that the remaining bottom layer of the body of the candle 22 is biased to pass through the hole 35. The root 28 extends longitudinally in the hole 35 with the wick 24 of the candle 20 in the root. This provides an alignment between the hole 35 and the wick 24, thereby resisting any displacement of the candle from a position above the hole 35 suitable to ensure the remaining portion consistently falls through the hole.

The final molten bottom layer of the candle 20 and the root 28 will fall, under gravity, so far as the filter 38, which acts as a net catching any solid matter, such as wick remnant but also any candle fuel about the wick that is not molten, and allowing any molten candle fuel to pass through. The filter 38 thermally contacts the socket and thus is heated by the burning candle 20 before it fell through the hole 35. This heating means that the molten candle fuel will not solidify on contact with the filter 38 and thus can pass through. Molten candle fuel has thus been separated from solid matter by the filter 38. The collection receptacle 40 receives the molten candle fuel.

The socket 34 is empty of the previous candle 20 because of the unique candle structure of the present disclosure as described above. A replacement candle 20 can thus be fitted into the socket 34 as described above without the socket needing to be cleaned out first. The replacement candle 20 will, as the flame is encompassed by the socket 34, start to heat the socket 34. The heated socket 34 will transfer heat to the filter 38 and any solid fuel sitting on the filter will melt away, for example any solid fuel of the root that was about the wick and that was not molten as the previous candle residue fell from the hole 35. The solid fuel of the previous candle's root will melt away from the wick of the root and pass through the filter 38 to be collected in the receptacle 40.

The residual candle fuel collected in the receptacle 40 can be extracted. This extraction is easier if the solid fuel is not attached to the receptacle 40, which makes the provision of cooling means in the receptacle advantageous as any molten solid fuel will have solidified before reaching the walls of the receptacle 40 and thus preventing the wax strongly bonding with these walls. In order to extract the collected candle fuel, the socket 34 is removed by lifting it, or a frame that it is attached to, off the receptacle 40 to enable access. The extracted candle fuel can be melted down and moulded into one or more new candles. The filter 38 may also be dismounted from attachment with the socket(s) 34 or frame supporting the sockets to allow remnant wicks to be removed.

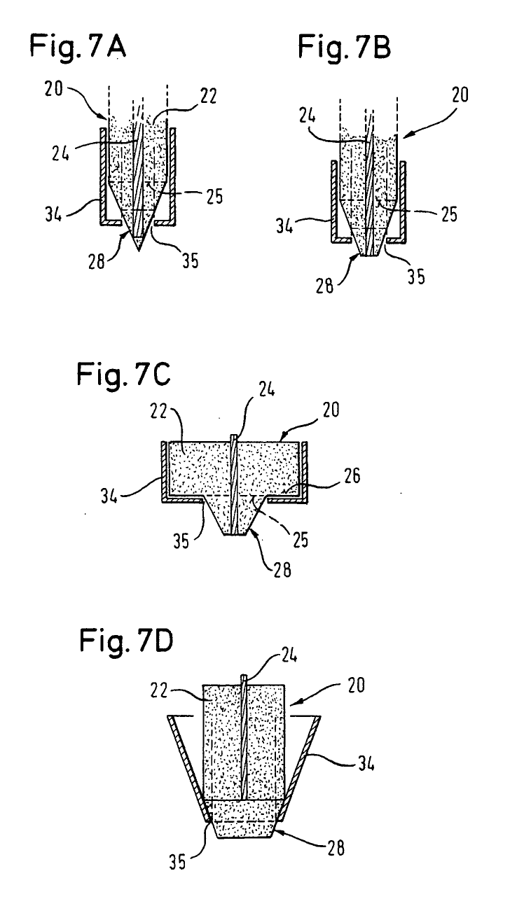

FIGS. 7A to 7D illustrate alternative forms of the candle 20 and candle socket 34 of the present disclosure. Just a butt portion of the candle 20 is shown in FIGS. 7A and 7B so as to concentrate on the aspects of these exemplary embodiments different from that disclosed in FIGS. 4 to 6.

The root 28 of FIG. 7A is provided as a cone extending from the body 22 of the candle 20. The root 28 is a butt end of the candle 20 that is sized to pass through a passage through the candle holding socket 34. The passage through the candle holding socket 34 includes the opening 35 in the base of the candle holding socket. The passage is defined by the cross-sectional extent of the hole 35 and extends longitudinally through the candle holding socket 34. The root 28 of this embodiment extends longitudinally in the hole 35 and through the hole 35. The root 28 is shown in an extended form for ease of illustration. It is to understood that a root of smaller longitudinal extent is contemplated, namely one of 2 mm or greater.

The cone shaped root 28 shown in FIG. 7A defines a tapered bottom to the candle 20. The cone shaped root 28 is defined by a butt end sized to extend through the hole 35 in the candle holding socket 34. The root 28 also provides an interface of the candle supported on a base of the candle holding socket 34 such that the candle 20 itself is supported on the base. As before, when the candle burns down it will form a bottom layer of candle fuel that is supported on the base of the candle holding socket 34. Once the bottom layer is sufficiently molten, the weight of the root portion extending in the hole 35 in the candle holding socket 34 pulls the remaining bottom layer of the candle 20 through the hole 35.

FIG. 7B offers a similar construction to that of FIG. 7A, but where the root 28 is formed as a frustum of a cone. The narrow portion of the frustum of a cone extends into and, in the shown configuration, through the hole 35 in the base of the candle holding socket 34. Again, it is the root 28 that interfaces with the base of the candle holding socket 34, rather than a base surface 26 of the candle body 22 as in FIGS. 4 to 6.

FIG. 7C offers yet another embodiment of a candle 20 according to the present disclosure where the candle 20 is of the dimensions and shape of well known tea lights. The difference from the well known tea light type candles is that the candle 20 includes a root 28 extending from a candle body 22. The candle 22 has an interface with the base of the candle holding socket 34 in the form of a planar base surface 26 of the candle seated on the base of the candle holding socket 34. The candle holding socket is provided in the form of a glass cup with a side wall extending from a base of the socket 34 with a hole 35 provided in the base. The candle 20 fits in the cup such that the root 28 passes into the hole 35.

Again, the root 28 appropriately positions the wick 24 in the cup so as to align the wick with the hole 35. The weight of the root 28 biases any residue of candle and wick of the candle body 22 to pass through the hole 35 when it burns down to a final bottom layer. The wick 24 remains upstanding by way of the support provided by the root even as the body 22 of the candle burns down to form a semi molten thin layer of candle fuel supported on the base surface of the candle holding socket 34. Once this bottom layer of candle fuel becomes sufficiently molten, it is pulled through the hole 35 by the weight of the root 28.

FIG. 7D shows yet another embodiment of the candle holding socket 34 and the candle 20 of the present disclosure. Here, the candle holding socket 34 is provided as a truncated cone extending inwardly in the downwards direction. Both ends of the truncated cone shaped candle holding socket 34 provides a hole. The smaller, bottom hole, provides a hole 35 through a bottom of the candle holding socket 34. A passage through the candle socket 34 is defined in cross-sectional extent by the hole 35 and can be imagined to extend longitudinally through the candle holding socket 34 and through the opening 35, as shown by the vertical dashed lines. The root 28 is defined as a butt end of the candle 20 that is sized to pass through the passage through the candle holding socket 34. In the shown embodiment, the root 28 extends longitudinally through the hole 35 in the bottom of the candle holding socket 34. The root 28 is provided in the form of a frustum of a cone.

The body 22 of the candle 20 is supported on the candle holding socket 34 where the sidewall of the socket is of a size so as to engage the candle body 22. It is the root 28 that is dimensioned to pass through the passage through the socket 34 and thus extends longitudinally into the hole in the bottom of the socket 34.

1. (canceled)

2. A candle assembly comprising a body of candle fuel with a wick extending longitudinally through the body, and a candle supported on a candle holding socket with a passage through the candle holding socket, said candle including a root forming a butt end of the candle, wherein the root extends longitudinally in the passage and away from the candle body and is sized to pass through the passage through the candle holding socket and a bottom portion of the wick is supported in the root.

3. The candle assembly of claim 2 wherein the candle holding socket comprises a base and the candle is supported on the base, the passage includes a bottom hole extending through the base and the root extends longitudinally in the hole.

4. The candle assembly of claim 2, wherein the candle socket includes a downwardly narrowing sidewall open to form holes at opposing top and bottom ends and the candle is supported on the sidewall and extends in the passage, the passage extending longitudinally through the socket and through the bottom hole.

5. The candle assembly of claim 3 wherein the candle extends through the bottom hole.

6. The candle assembly of claim 2 wherein the root is made of candle fuel supporting the bottom portion of the wick in the root of candle fuel.

7. The candle assembly of claim 2 wherein a bottom of the body of the candle has a base surface for being seated on a base of a candle holding socket, the base surface defining a border around the root and the root extends longitudinally from the base surface.

8. The candle assembly of claim 7, wherein the base surface is planar and extends in a plane perpendicular to the longitudinal direction of the candle.

9. The candle assembly of claim 6 wherein the root extends longitudinally by an amount of 2 mm or greater.

10. The candle assembly of claim 6 wherein the root has a greatest cross-sectional dimension of 2 mm or greater.

11. The candle assembly of claim 2 wherein the as least one socket is associated with a collection receptacle arranged to receive candle residue passing through the candle socket.

12. The candle assembly of claim 11, further comprising a filter arranged between the passage through the socket and the collection receptacle so that the filter is positioned to receive candle residue passing from the candle socket, wherein the filter is for retaining solid candle residue from the candle on the filter and allowing molten candle fuel to pass through the filter.

13. (canceled)

14. The candle assembly of claim 12, wherein the filter is a metal mesh.

15. The candle assembly of claim 12 wherein the filter has an attachment point to the candle socket.

16. A method of making a candle comprising a body of candle fuel and a wick extending longitudinally through the body, comprising providing the body of candle fuel with a root extending away from the body, the root forming a butt end of the candle, wherein the candle so made is to be supported on a candle holding socket and the root is sized to pass through a passage through the candle holding socket and to extend longitudinally through the candle holding socket so that the wick extends longitudinally through the body of the candle and into the root such that a bottom portion of the wick is supported in the root.
